(19) United States
(12) Patent Application Publication
(10) Pub. No.: US 2026/0086060 A1
(43) Pub. Date: Mar. 26, 2026

(54) SYSTEM AND METHOD FOR IN-LINE MONITORING OF A QUALITY CHARACTERISTIC OF A SLURRY

(71) Applicant: GM GLOBAL TECHNOLOGY OPERATIONS LLC., Detroit, MI (US)

(72) Inventors: Mengyuan Chen, Madison Heights, MI (US); Bradley R. Frieberg, Farmington Hills, MI (US); Xiaosong Huang, Novi, MI (US); John P. Healy, Rochester Hills, MI (US); Selina X. Zhao, Rochester Hills, MI (US)

(73) Assignee: GM GLOBAL TECHNOLOGY OPERATIONS LLC, Detroit, MI (US)

(21) Appl. No.: 18/897,320

(22) Filed: Sep. 26, 2024

(51) Int. Cl. G01N 27/07; G01N 27/10; G01N 27/22; H01M 4/04; H01M 4/66

(52) U.S. Cl. CPC G01N 27/07; G01N 27/10; G01N 27/221; G01N 27/226; H01M 4/664; H01M 4/04

(57) ABSTRACT

A system for in-line monitoring of a quality characteristic of a slurry includes a vessel configured to receive the slurry within a vessel interior, one or more stirrers disposed within the vessel interior for stirring the slurry, and a sensor for sensing the quality characteristic. In a first design, the sensor is disposed within the defined volume and outside a collective paddle-swept volume. In a second design, the sensor has a sensing surface that is disposed within a conduit that is outside a vessel side wall, wherein the conduit includes an inlet and an outlet that are in fluid communication with the vessel interior. A method is also provided for utilizing each of the first and second designs.

### INTRODUCTION

This disclosure relates generally to systems and methods for in-line monitoring of a quality characteristic of a slurry, such as a battery electrode slurry.

As part of the manufacturing process for batteries, such as lithium ion batteries, it is common practice to test battery electrode slurries in an ex situ, batch process manner. For example, a sample of the battery electrode slurry may be drawn from the processing equipment and taken to a test bench, and one or more chemical, rheological or other characteristics of the slurry are assessed, such as the viscosity of the slurry in response to shear or the fineness of ground (FoG) of the aggregates and components of the slurry. This type of batch process/ex situ testing must be periodically repeated in order to monitor the overall quality of the slurry.

### SUMMARY

The present disclosure reveals various embodiments of a system, designs and methods for in-line monitoring of a quality characteristic of a slurry which are significant advancements over previously known approaches.

According to one embodiment, a system for in-line monitoring of a quality characteristic of a slurry includes: (i) a vessel having a vessel side wall defining a vessel interior, wherein the vessel is configured to receive the slurry and to contain the slurry within a defined volume that is within the vessel interior; (ii) one or more stirrers each having a respective elongate spindle and a respective one or more paddles attached to and extending radially outward from the respective spindle, wherein each spindle has a respective spindle axis and wherein the one or more stirrers are disposed with each spindle oriented in a respective generally vertical, generally horizontal or generally diagonal orientation with the respective one or more paddles disposed within the defined volume, wherein each of the one or more stirrers is configured for rotation about its respective spindle axis such that rotation of the respective one or more paddles sweeps out and defines a respective individual paddle-swept volume, wherein a totality of the individual paddle-swept volume defines a collective paddle-swept volume; and (iii) a sensor disposed within the defined volume and outside the collective paddle-swept volume, wherein the sensor is configured for sensing the quality characteristic.

The quality characteristic may be at least one of resistivity and dielectric permittivity.

For each of the one or more stirrers, the respective one or more paddles may be attached to the stirrer via a respective one or more arms.

The vessel may have a generally vertically oriented longitudinal axis, wherein one or more of the one or more stirrers are disposed with their respective spindle axes being generally colinearly aligned with the longitudinal axis.

The vessel may have a vessel radius as measured from the longitudinal axis and wherein the collective paddle-swept volume extends radially outward from the longitudinal axis to a maximum paddle-swept radius, such that the maximum paddle-swept radius is less than the vessel radius.

The sensor may be disposed at a sensor radius as measured from the longitudinal axis, such that the sensor radius is greater than the maximum paddle-swept radius and less than the vessel radius.

The system may further include an elongate extension having a top extension end and a bottom extension end, wherein the extension is disposed in a generally vertical orientation with the bottom extension end attached to the sensor.

The extension may be configured as a tube having a lumen therein, and at least one sensor wire may extend within the lumen and may be operably connected with the sensor.

The sensor may be configured for at least one of continuous monitoring and intermittent monitoring.

The slurry may be a battery electrode slurry containing ceramic particles therein.

The sensor may be positioned within the defined volume at a location having a lowest flow rate during rotation of the one or more stirrers.

The sensor may include at least one of a surface coating of a ceramic material on a sensing surface of the sensor, a baffle disposed so as to at least partially block a flow of the slurry to the sensing surface and configured to reduce at least one of a velocity and a turbulence of the slurry impinging on the sensing surface, and a case surrounding the sensing surface and having a flow inlet for admitting the slurry into a chamber within which the sensing surface is disposed and a flow outlet for admitting the slurry out of the chamber.

The case may include at least one of a case inlet valve in fluid communication with the flow inlet, a case outlet valve in fluid communication with the flow outlet, and a conductive shielding on at least one of an inner case surface and an outer case surface of the case.

According to another embodiment, a system for in-line monitoring of a quality characteristic of a slurry includes: (i) a vessel having a vessel side wall defining a vessel interior and a conduit disposed outside the vessel side wall, wherein the conduit includes a conduit inlet in fluid communication with the vessel interior and a conduit outlet in fluid communication with the vessel interior, wherein the vessel is configured to receive the slurry and to contain the slurry within a defined volume that is within the vessel interior and the conduit; (ii) one or more stirrers disposed within the vessel interior and configured for stirring the slurry; and (iii) a sensor having a sensing surface that is disposed within the conduit, wherein the sensor is configured for sensing the quality characteristic.

The sensor may be configured for at least one of continuous monitoring and intermittent monitoring.

The sensor may include at least one of a surface coating of a ceramic material on a sensing surface of the sensor, a baffle disposed so as to at least partially block a flow of the slurry to the sensing surface and configured to reduce at least one of a velocity and a turbulence of the slurry impinging on the sensing surface, and a case surrounding the sensing surface and having a flow inlet for admitting the slurry into a chamber within which the sensing surface is disposed and a flow outlet for admitting the slurry out of the chamber.

The case may include at least one of a case inlet valve in fluid communication with the flow inlet, a case outlet valve in fluid communication with the flow outlet, and a conductive shielding on at least one of an inner case surface and an outer case surface of the case.

The conduit may include at least one of a conduit inlet valve in fluid communication with the conduit inlet, a conduit outlet valve in fluid communication with the conduit outlet, and a flow rate controller disposed in a conduit channel of the conduit for regulating a flow rate of the slurry through the conduit channel.

The conduit may include a conductive shielding on at least one of an inner conduit surface and an outer conduit surface of the conduit.

According to yet another embodiment, a method for in-line monitoring of a quality characteristic of a slurry includes: (a) providing a system which includes (i) a vessel having a vessel side wall defining a vessel interior, wherein the vessel is configured to receive the slurry and to contain the slurry within a defined volume that is within the vessel interior; (ii) one or more stirrers each having a respective elongate spindle and a respective one or more paddles attached to and extending radially outward from the respective spindle, wherein each spindle has a respective spindle axis and wherein the one or more stirrers are disposed with each spindle oriented in a respective generally vertical, generally horizontal or generally diagonal orientation with the respective one or more paddles disposed within the defined volume, wherein each of the one or more stirrers is configured for rotation about its respective spindle axis such that rotation of the respective one or more paddles sweeps out and defines a respective individual paddle-swept volume, wherein a totality of the individual paddle-swept volumes defines a collective paddle-swept volume; and (iii) a sensor disposed within the defined volume and outside the collective paddle-swept volume; (b) adding the slurry into the vessel; (c) stirring the slurry with the one or more stirrers; and (d) sensing the slurry with the sensor so as to determine the quality characteristic of the slurry.

According to yet a further embodiment, a method for in-line monitoring of a quality characteristic of a slurry includes: (a) providing a system which includes (i) a vessel having a vessel side wall defining a vessel interior and a conduit disposed outside the vessel side wall, wherein the conduit includes a conduit inlet in fluid communication with the vessel interior and a conduit outlet in fluid communication with the vessel interior, (ii) one or more stirrers disposed within the vessel interior and configured for stirring the slurry, and (iii) a sensor having a sensing surface that is disposed within the conduit; (b) adding the slurry into the vessel; (c) stirring the slurry with the one or more stirrers; and (d) sensing the slurry within the conduit with the sensor so as to determine the quality characteristic of the slurry. The system may include a conduit channel defined within the conduit and fluidly coupling the conduit inlet and the conduit outlet, and the method may further include: (e) opening one or both of a conduit inlet valve disposed in the conduit channel proximate the conduit inlet and a conduit outlet valve disposed in the conduit channel proximate the conduit outlet. The method may also include: (f) closing one or both of the conduit inlet valve and the conduit outlet valve.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic, cross-sectional side view of a system for in-line monitoring of a quality characteristic of a slurry, according to a first design.

FIGS. 2-3 are schematic, cross-sectional top views of the system of FIG. 1 as viewed along line I-I, according to two different configurations.

FIG. 4 is a schematic, cross-sectional side view of a system for in-line monitoring of a quality characteristic of a slurry, according to a second design.

FIGS. 5-6 are schematic, cross-sectional top views of the system of FIG. 4 as viewed along line II-II, according to two different configurations.

FIG. 7 is a schematic side view of a sensor having a baffle and a case.

FIG. 8 is a block diagram of a slurry composition.

FIG. 9 is a block diagram of various quality characteristics.

FIG. 10 is a flow diagram of a case for a sensor.

FIG. 11 is a flow diagram of a conduit for the second design.

FIG. 12 is a flowchart of a first method for in-line monitoring of a quality characteristic of a slurry, for use with the first design of the system.

FIG. 13 is a flowchart of a second method for in-line monitoring of a quality characteristic of a slurry, for use with the second design of the system.

### DETAILED DESCRIPTION

Referring now to the drawings, wherein like numerals indicate like parts in the several views, a system 20 and methods 100, 200 for in-line monitoring of a quality characteristic QC of a slurry 10 are shown and described herein, according to a first design D1 and a second design D2, as described in detail below. This system 20 and the designs D1, D2 and methods 100, 200 are significant advancements over previously known batch process/ex situ testing approaches that must be periodically and separately repeated, as the system 20 and methods 100, 200 disclosed herein provide approaches for in-line/in situ monitoring of one or more quality characteristics QC of a slurry 10 in real time.

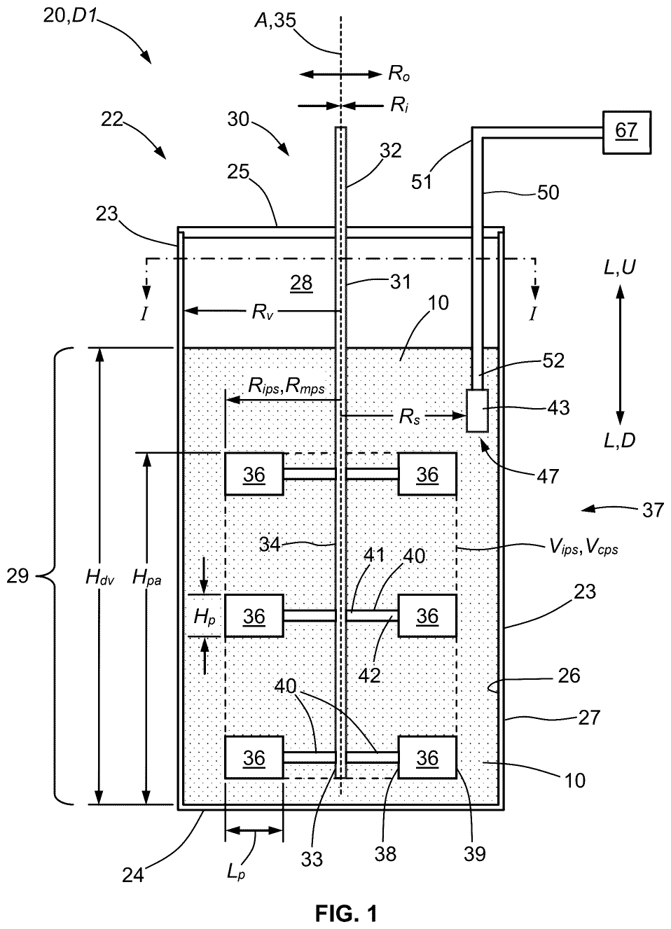

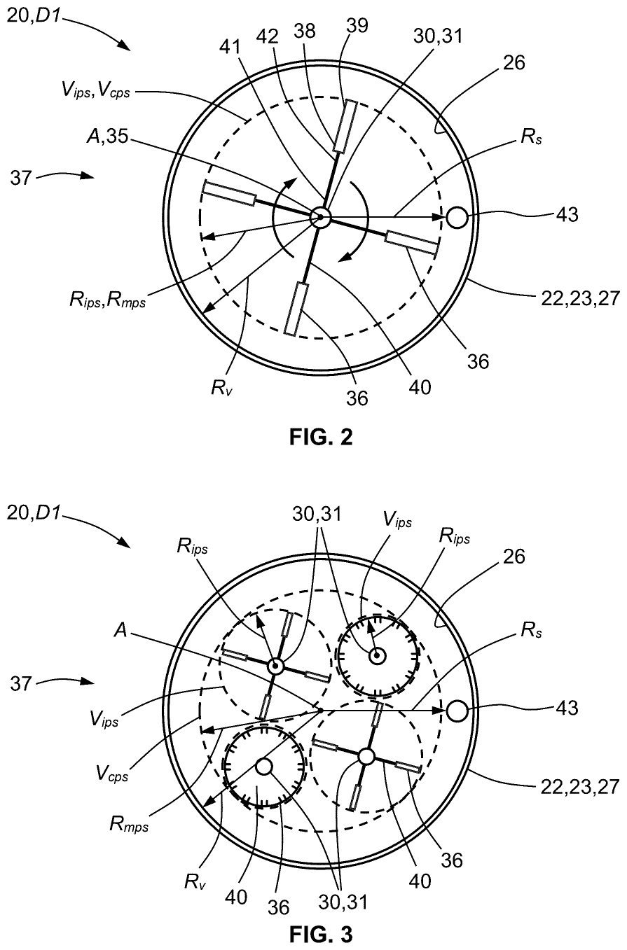

Beginning with the first design D1, FIG. 1 shows a schematic, cross-sectional side view of a system 20 for in-line monitoring of a quality characteristic QC of a slurry 10, and FIGS. 2-3 show schematic, cross-sectional top views of the system 20 of FIG. 1 as viewed along line I-I, according to two different configurations.

In this first design D1, the system 20 includes a vessel 22, one or more stirrers 30, and a sensor 43 configured for sensing the quality characteristic QC. The vessel 22 has a vessel side wall 23 which defines a vessel interior 28 within the vessel 22. The vessel 22 is configured to receive the slurry 10 (e.g., via pipes or ductwork, which are not shown) and to contain the slurry 10 within a defined volume 29 that is within the vessel interior 28. For example, the vessel 22 may have a generally cylindrical shape (or any other suitable shape) and a generally vertically oriented longitudinal axis A, with a vessel radius Rᵥ as measured from the longitudinal axis A. A longitudinal direction L may be parallel to the longitudinal axis A, with the longitudinal direction L defining opposed upward and downward directions U, D, as well as a radially outward direction Rₒ pointing outward from the longitudinal axis A and a radially inward direction Rᵢ pointing toward from the longitudinal axis A.

In addition to the vessel side wall 23, the vessel 22 may have a vessel bottom 24 and an optional vessel top or lid 25. The vessel side wall 23 may have an interior surface 26 and an exterior surface 27. As noted above, the vessel 22 is configured to receive and contain the slurry 10 within a defined volume 29, such that a top surface of the slurry 10 within the vessel interior 28 may reach up to a defined volume height H_{dv} as measured from the vessel bottom 24; this defined volume height H_{dv} may be less than the full height of the vessel interior 28.

The system 20 may include a single stirrer 30, as illustrated in FIGS. 1-2, or it may include multiple stirrers 30, as illustrated in FIG. 3 where four stirrers 30 are shown. Note that a “stirrer”, as used herein, may include any element or device which may be used to stir, agitate, impel, mix or otherwise move the slurry 10 within the vessel 22. Each stirrer 30 may have an elongate spindle 31 that has a top spindle end 32, a bottom spindle end 33 and a spindle axis 35 running between the top and bottom spindle ends 32, 33. A stirrer 30 may be disposed such that its spindle 31 is oriented in a generally vertical orientation, such as through the optional vessel top 25 as illustrated in FIG. 1 (as well as in FIGS. 2-3). For example, if the vessel 22 has a generally vertical longitudinal axis A, then a stirrer 30 may be disposed in a generally vertical orientation such that the stirrer's spindle axis 35 is generally colinearly aligned with the longitudinal axis A. Alternatively, the spindle 31 may be oriented in a generally horizontal or generally diagonal orientation (such as through the vessel top 25 or the vessel side wall 23). Regardless of the orientation of the stirrer 30 and its spindle 31, the bottom spindle end 33 may be disposed within the defined volume 29, while the top spindle end 32 may be disposed outside the vessel 22 or optionally within the vessel 22 (e.g., within the open space above the top surface of the slurry 10). An electric, hydraulic, pneumatic or mechanically driven motor (not shown) may be operably attached to each stirrer 30 at the top spindle end 32 in order to rotate the stirrer 30 about its spindle axis 35.

Each stirrer 30 may also have one or more paddles 36, with each paddle 36 being attached to a lower spindle portion 34 of the spindle 31. Each paddle 36 may extend radially outward from the stirrer's spindle 31 to an individual paddle-swept radius Rᵢₚₛ, with each of the one or more paddles 36 being disposed within the defined volume 29. All of the paddles 36 used in the system 20 taken together may define a paddle array 37, which extends upward from the vessel bottom 24 to a paddle array height Hₚₐ. As each stirrer 30 is rotated about its stirrer axis 35, the one or more paddles 36 are also rotated about the stirrer axis 35. As the one or more paddles 36 of a stirrer 30 are thusly rotated, they may sweep out and define an individual paddle-swept volume Vᵢₚₛ. For example, in the configuration shown in FIGS. 1-2 where only one stirrer 30 is used, a single individual paddle-swept volume Vᵢₚₛ is swept out by the stirrer 30. However, in FIG. 3 where four stirrers 30 are used, each stirrer 30 sweeps out its own respective individual paddle-swept volume Vᵢₚₛ, thus resulting in a total of four individual paddle-swept volumes Vᵢₚₛ.

A totality or aggregation of the individual paddle-swept volumes Vᵢₚₛ may define a collective paddle-swept volume V_{cps}. In configurations where the system 20 includes only one stirrer 30, such as in FIGS. 1-2, the collective paddle-swept volume V_{cps} may be the same as the individual paddle-swept volume Vᵢₚₛ; and in configurations where the system 20 includes two or more stirrers 30, such as in FIG. 3, the collective paddle-swept volume V_{cps} may be formed by an aggregation of the multiple individual paddle-swept volumes Vᵢₚₛ. The collective paddle-swept volume V_{cps} may extend radially outward from the longitudinal axis A of the vessel 22 to a maximum paddle-swept radius Rₘₚₛ, such that the maximum paddle-swept radius Rₘₚₛ is less than the vessel radius Rᵥ.

Note that a “paddle”, as used herein, may include any portion of a stirrer 30 which may be used to stir, agitate, impel, mix or otherwise move the slurry 10 within the vessel 22 as the stirrer 30 is rotated about its spindle axis 35. A paddle 36 may assume any suitable size, shape and orientation. For example, a paddle 36 may be shaped as a relatively low aspect ratio paddle, a relatively high aspect ratio blade, or any other suitable shape. Each paddle 36 may have a paddle length Lₚ and a paddle height Hₚ. (Note that while FIG. 1 shows a paddle length Lₚ measured along the radial inward and outward directions Rᵢ, Rₒ and a paddle height Hₚ measured along the upward and downward directions U, D, it should be noted that the paddle length Lₚ and paddle height Hₚ may be measured along other directions as well.) Additionally, a paddle 36 may be oriented and attached to a spindle 31 such that when the spindle 31 rotates and the paddle 36 is rotated about the spindle axis 35, the paddle's major surface faces directly into the path of rotation (i.e., the major surface is orthogonal to the tangential component of the rotational path); alternatively, the paddle's major surface may be angled with respect to the path of rotation (i.e., the major surface is non-orthogonal to the tangential component of the rotational path).

Each paddle 36 may have a first paddle end 38 and a second paddle end 39, and these first and second paddle ends 38, 39 may be opposed from each other. Each paddle 36 may be attached to the stirrer 30 via one or more arms 40, with each arm 40 having a first arm end 41 and a second arm end 42. For example, a first paddle end 38 may be attached to a second arm end 42, with the first arm end 41 being attached to the spindle 31 and the second paddle end 39 being distal from the spindle 31, such as illustrated in FIGS. 1-2. As another example, a paddle 36 may have an arm 40 attached at each of the first and second paddle ends 38, 39, with both of these arms 40 being attached to the spindle 31. As a further example, an arm 40 may be shaped as a disc with multiple paddles 36 distributed around the outer circumferential perimeter of the disc-shaped arm 40, as illustrated by the two smaller stirrers 30 shown in FIG. 3.

As noted above, the paddles 36 (as well as the arms 40, spindles 31 and stirrers 30) may be presented in a variety of different configurations. These configurations may include dispersion blades, Cowles blades, helical mixing blades, louvered blades, sawtooth blades, flat paddles, curved/concave paddles, etc.

The abovementioned sensor 43 may be configured for one or both of continuous monitoring and intermittent monitoring of the slurry's quality characteristic QC. The sensor 43 may be disposed within the defined volume 29 and outside of the collective paddle-swept volume V_{cps}. For example, the sensor 43 may be positioned within the defined volume 29 at a location 47 that has a lowest flow rate during rotation of the one or more stirrers 30. This location 47 may be determined empirically by direct measurements of the flow rate profile within the defined volume 29, or it may be determined or modeled computationally, such as by utilizing computational fluid dynamics (CFD) methods.

In some configurations, the sensor 43 may be disposed within the defined volume 29 at a sensor radius Rₛ as measured from the longitudinal axis A, such that the sensor radius Rₛ is greater than the maximum paddle-swept radius Rₘₚₛ and less than the vessel radius Rᵥ. In other configurations, the sensor 43 may be disposed at a location within the defined volume 29 that is above the top(s) of the one or more paddles 36, such as above the paddle array height Hₚₐ. For example, the configuration illustrated in FIG. 1 shows the sensor 43 in a location 47 that is both above the paddle array height Hₚₐ and at a sensor radius Rₛ that is greater than the maximum paddle-swept radius Rₘₚₛ and less than the vessel radius Rᵥ.

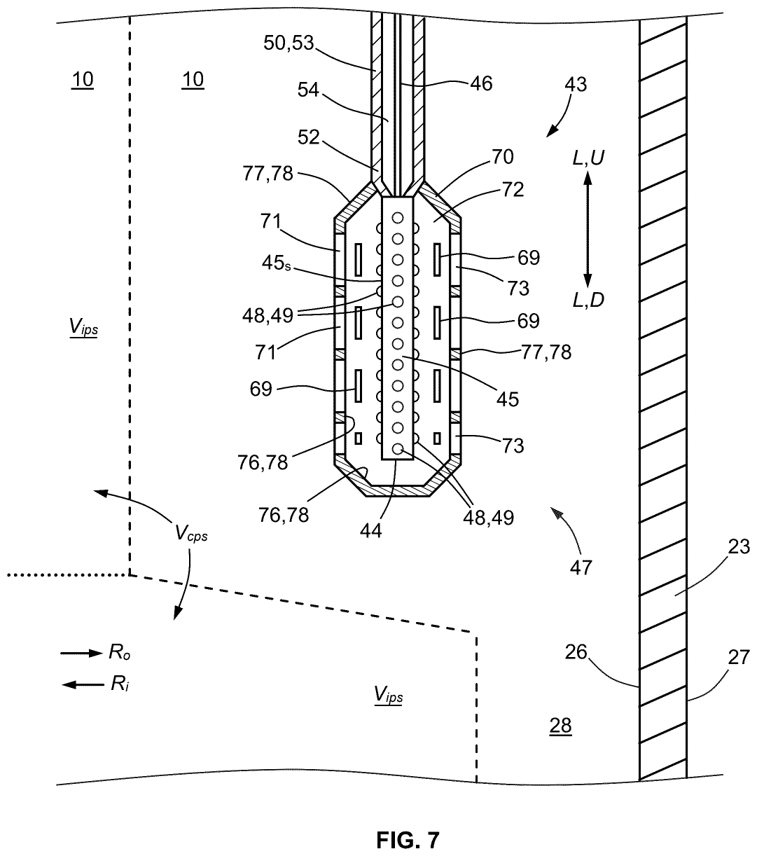

FIG. 7 shows a schematic side view of a sensor 43 submerged in a slurry 10 within a vessel interior 28. Note that the dashed lines indicate the outer boundaries of an upper individual paddle-swept volume Vᵢₚₛ and a lower individual paddle-swept volume Vᵢₚₛ, with a horizontal dotted line separating the upper and lower individual paddle-swept volume Vᵢₚₛ, and with both individual paddle-swept volumes Vᵢₚₛ together defining collective paddle-swept volume V_{cps}. Here, the sensor 43 is shown being disposed in a radially outward direction Rₒ from the upper individual paddle-swept volume Vᵢₚₛ and in a longitudinally upward direction U from the lower individual paddle-swept volume Vᵢₚₛ, with the sensor 43 having a sensor body 44 (e.g., a main portion) which may comprise a sensor element 45 having a sensing surface 45ₛ. Optionally, the sensor 43 may include a surface coating 48 of a suitable ceramic material 49 on the sensing surface 45ₛ to protect the sensing surface 45ₛ (e.g., from the impact of ceramic particles 14 in the slurry 10).

The sensor 43 may also optionally include a case 70 and one or more baffles 69, as illustrated schematically in FIG. 7 and in the flow/block diagram of FIG. 10. The one or more baffles 69 may be disposed so as to at least partially block a flow of the slurry 10 to the sensing surface 45ₛ, and may be configured to reduce the velocity V and/or turbulence T of the slurry 10 that impinges on the sensing surface 45ₛ as the slurry 10 moves along a direction of flow DOF. For example, as shown in FIG. 10, the flow of slurry 10 may have a first velocity V₁ and a first turbulence T₁ before or upstream of the one or more baffles 69, and a second velocity V₂ and a second turbulence T₂ after or downstream of the one or more baffles 69, wherein V₁>V₂ and T₁ >T₂. The case 70 may surround or shroud the sensing surface 45ₛ of the sensor 43. The case 70 may have one or more flow inlets 71 for admitting the slurry 10 into a chamber 72 within which the sensing surface 45ₛ is disposed, and one or more flow outlets 73 for admitting the slurry 10 out of the chamber 72. The case 70 may include one or more of a case inlet valve 74 that is in fluid communication with the flow inlet 71, a case outlet valve 75 that is in fluid communication with the flow outlet 73, and an electrically conductive shielding 78 on one or both of an inner case surface 76 and an outer case surface 77 of the case 70 to reduce potential electromagnetic interference.

Returning now to FIG. 1, the system 20 may further include an elongate extension 50 having a top extension end 51 and a bottom extension end 52, wherein the extension 50 is disposed in a generally vertical orientation with the bottom extension end 52 attached to the sensor 43. The extension 50 may be configured as a tube 53 having a lumen 54 therein, and at least one sensor wire 46 may extend within the lumen 54 and may operably connect the sensor 43 with a sensor data acquisition system 67. The extension 50 may be made of a corrosion-resistant and/or chemical-resistant material, such as a suitably alloyed or coated metal or a suitably coated plastic, depending upon the chemicals used in the slurry 10. Although the extension 50 is depicted in FIG. 1 as passing through the vessel top 25 and being in a generally vertical orientation, the extension 50 may also pass through the vessel wall 23 (with suitable seals, O-rings or the like to prevent the slurry 10 from leaking out), and/or the extension 50 may be disposed in a generally horizontal or generally diagonal orientation.

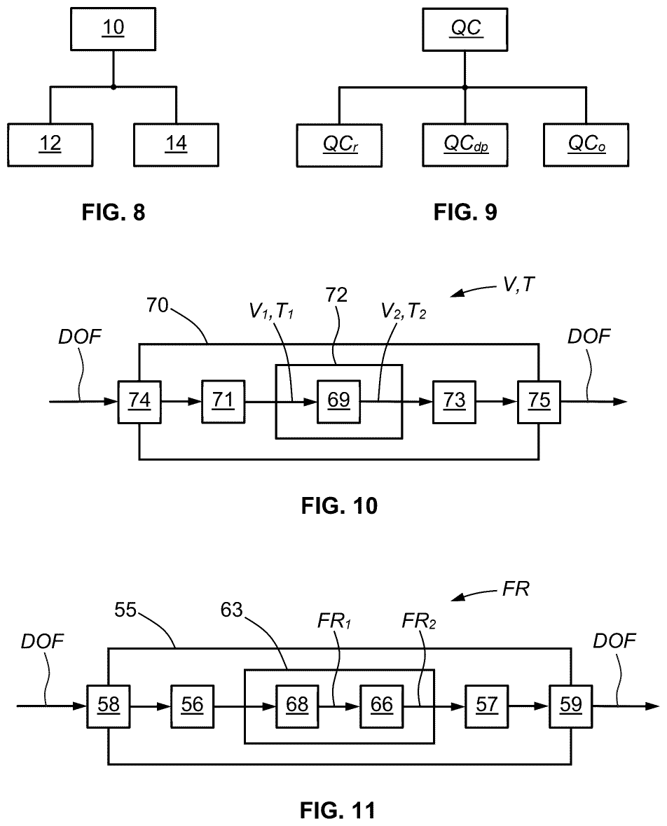

As illustrated in FIG. 8, the slurry 10 may be a battery electrode slurry 12 containing ceramic particles 14 therein. For example, the battery electrode slurry 12 may be for a lithium ion battery and may contain an active material (e.g., LiCoO₂, LiNiO₂, LiNiMnCoO₂) which provides lithium ions, an organic solvent (e.g., N-methyl-2-pyrrolidone, or NMP), a polymer binder (e.g., polyvinylidene fluoride, or PVDF) and a conductive additive (e.g., carbon black), and the ceramic particles 14 in the battery electrode slurry 12 may be alumina, silica, alumino-silicate, zirconium silicate, etc.

As illustrated by the block diagram shown in FIG. 9, the quality characteristic QC may be a resistivity QCᵣ of the slurry 10, a dielectric permittivity QC_{dp} of the slurry 10, and/or some other quality characteristic QCₒ of the slurry 10.

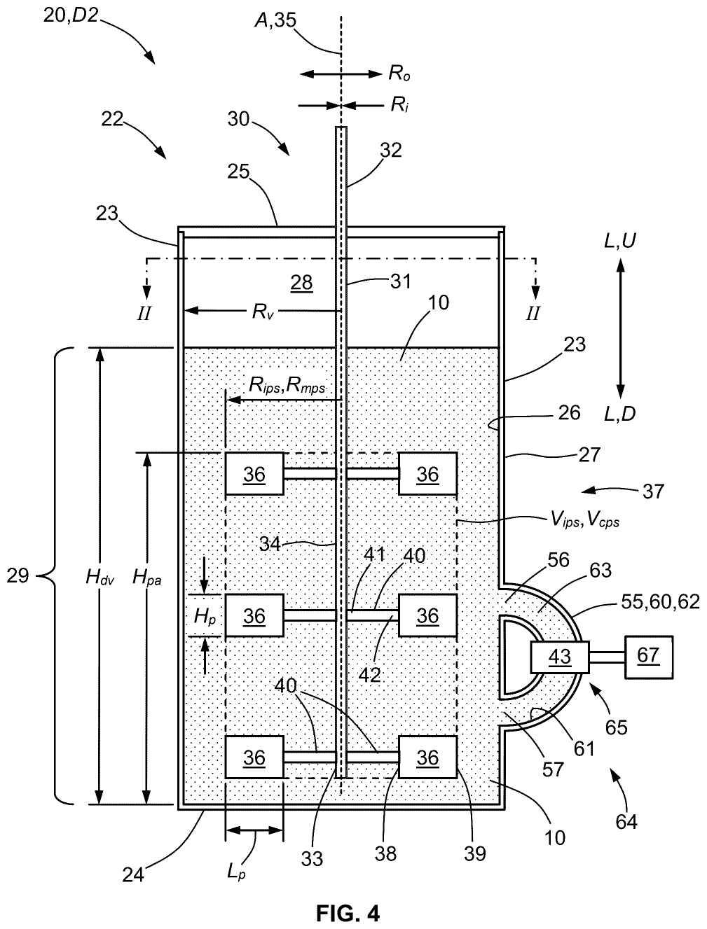

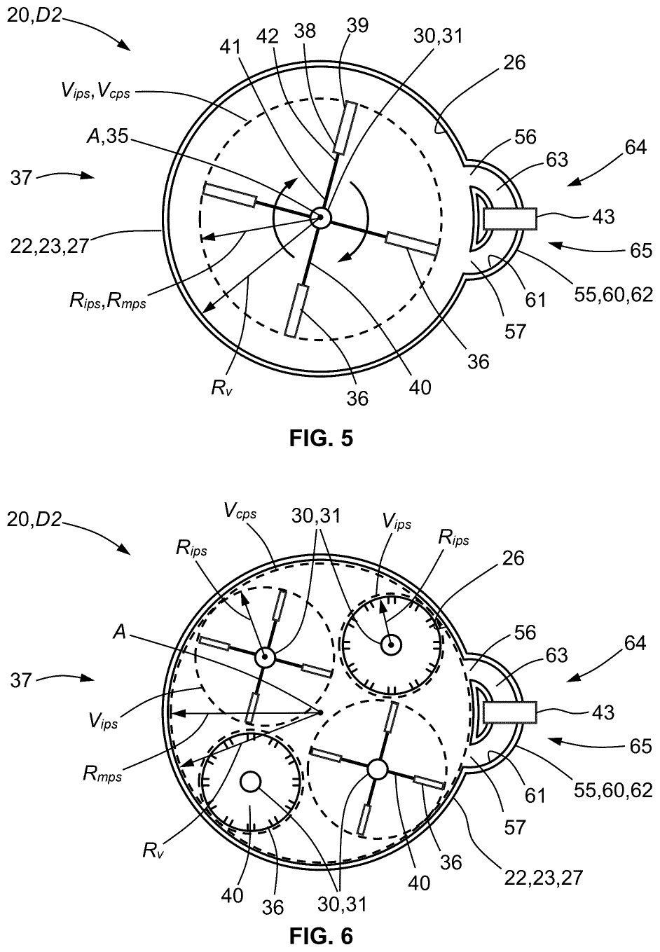

Proceeding onward now to the second design D2, FIG. 4 shows a schematic, cross-sectional side view of a system 20 for in-line monitoring of a quality characteristic QC of a slurry 10, and FIGS. 5-6 show schematic, cross-sectional top views of the system 20 of FIG. 4 as viewed along line II-II, according to two different configurations.

In this second design D2, the system 20 includes a vessel 22, one or more stirrers 30, and a sensor 43 configured for sensing the quality characteristic QC. The vessel 22 shown here for the second design D2 is similar to the vessel 22 shown for the first design D1, except that here the vessel 22 includes a conduit 55 that is external to the vessel 22. Here, the vessel 22 has a vessel side wall 23 which defines a vessel interior 28, and a conduit 55 disposed outside the vessel side wall 23 and having a conduit wall 60. The conduit 55 includes a conduit inlet 56 in fluid communication with the vessel interior 28, and a conduit outlet 57 that is also in fluid communication with the vessel interior 28, with a conduit channel 63 in fluid communication with the conduit inlet and outlet 56, 57. Note that the conduit 55 may be oriented in a generally vertical orientation such that the conduit inlet 56 is positioned above the conduit outlet 57 as illustrated in FIG. 4, or in a generally horizontal orientation such that the conduit inlet and outlet 56, 57 are positioned at about the same height as each other (e.g., as measured from the vessel bottom 24) as illustrated in FIGS. 5-6, or in other suitable orientations, such as a generally diagonal orientation. The conduit 55 may have a generally arcuate or curved overall shape 64 with an apex 65 extending outward from exterior surface 27 of the vessel side wall 23. The vessel 22 is configured to receive the slurry 10 and to contain the slurry 10 within a defined volume 29, where the defined volume 29 here in the second design D2 is found within both the vessel interior 28 and the conduit 55. The one or more stirrers 30 are disposed within the vessel interior 28 and are configured for stirring the slurry 10, and the sensor 43 has a sensing surface 45ₛ that is disposed within the conduit 55. Optionally, the sensing surface 45ₛ may be disposed at or near the apex 65 of the conduit 55.

FIG. 11 shows a block/flow diagram of a conduit 55 for the second design D2. As shown in the diagram, the conduit 55 may include one or more of a conduit inlet valve 58 in fluid communication with the conduit inlet 56, a conduit outlet valve 59 in fluid communication with the conduit outlet 57, a pump 68, and a flow rate controller 66 disposed in the conduit channel 63 for regulating a flow rate FR of the slurry 10 through the conduit channel 63. The flow of slurry 10 may have a first flow rate FR₁ before or upstream of the flow rate controller 66, and a second flow rate FR₂ that is after or downstream of the flow rate controller 66, such that FR₁>FR₂. Note that while FIG. 11 shows the elements in a particular order along the direction of flow DOF—i.e., a conduit inlet valve 58, then a conduit inlet 56, then a pump 68, then a flow rate controller 66, then a conduit outlet 57, and then a conduit outlet valve 59—it should be noted that these elements may appear in a different order from the example shown. Optionally, the conduit 55 may include an electrically conductive shielding 78 on one or both of an inner conduit surface 61 of the conduit wall 60 and an outer conduit surface 62 of the conduit wall 60.

Now that the first and second designs D1, D2 have been disclosed, it may now be seen how the system 20 may be used in respective first and second methods 100, 200 for in-line monitoring of a quality characteristic QC of a slurry 10.

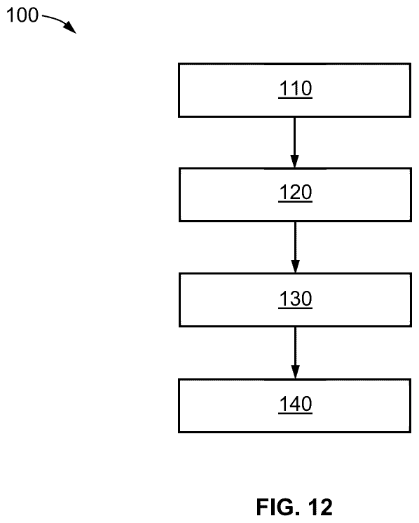

FIG. 12 shows a flowchart of the first method 100. At block 110, a system 20 according to the first design D1 is provided. which includes: (i) a vessel 22 having a vessel side wall 23 defining a vessel interior 28, wherein the vessel 22 is configured to receive the slurry 10 and to contain the slurry 10 within a defined volume 29 that is within the vessel interior 28; (ii) one or more stirrers 30 each having a respective elongate spindle 31 and a respective one or more paddles 36 attached to and extending radially outward from the respective spindle 31, wherein each spindle 31 has a respective spindle axis 35 and wherein the one or more stirrers 30 are disposed with each spindle 31 oriented in a respective generally vertical, generally horizontal or generally diagonal orientation with the respective one or more paddles 36 disposed within the defined volume 29, wherein each of the one or more stirrers 30 is configured for rotation about its respective spindle axis 35 such that rotation of the respective one or more paddles 36 sweeps out and defines a respective individual paddle-swept volume Vᵢₚₛ, wherein a totality of the individual paddle-swept volumes Vᵢₚₛ defines a collective paddle-swept volume V_{cps}; and (iii) a sensor 43 disposed within the defined volume 29 and outside the collective paddle-swept volume V_{cps}. At block 120, the slurry 10 is added into the vessel 22. At block 130, the slurry 10 is stirred with the one or more stirrers 30. And at block 140, the slurry 10 is sensed with the sensor 43 so as to determine the quality characteristic QC of the slurry 10.

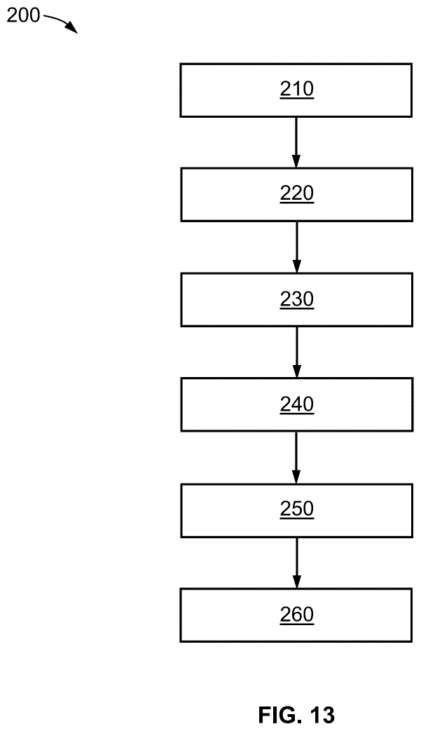

FIG. 13 shows a flowchart of the second method 200. At block 210, a system 20 according to the second design D2 is provided. which includes: (i) a vessel 22 having a vessel side wall 23 defining a vessel interior 28 and a conduit 55 disposed outside the vessel side wall 23, wherein the conduit 55 includes a conduit inlet 56 in fluid communication with the vessel interior 28 and a conduit outlet 57 in fluid communication with the vessel interior 28, (ii) one or more stirrers 30 disposed within the vessel interior 28 and configured for stirring the slurry 10, and (iii) a sensor 43 having a sensing surface 45ₛ that is disposed within the conduit 55. At block 220, the slurry 10 is added into the vessel 22. At block 230, the slurry 10 is stirred with the one or more stirrers 30. And at block 250, the slurry 10 is sensed within the conduit 55 with the sensor 43 so as to determine the quality characteristic QC of the slurry 10.

In this second method 200, the system 20 may include a conduit channel 63 defined within the conduit 55 and fluidly coupling the conduit inlet 56 and the conduit outlet 57, and the method 200 may further include, at block 240, opening one or both of a conduit inlet valve 58 disposed in the conduit channel 63 proximate the conduit inlet 56 and a conduit outlet valve 59 disposed in the conduit channel 63 proximate the conduit outlet 57. The method 200 may also include, at block 260, closing one or both of the conduit inlet valve 58 and the conduit outlet valve 59.

As one having skill in the relevant art will appreciate, the system 20 and method 100 of the present disclosure may be presented or arranged in a variety of different configurations and embodiments.

According to one embodiment, a system 20 for in-line monitoring of a quality characteristic QC of a slurry 10 includes: (i) a vessel 22 having a vessel side wall 23 defining a vessel interior 28, wherein the vessel 22 is configured to receive the slurry 10 and to contain the slurry 10 within a defined volume 29 that is within the vessel interior 28; (ii) one or more stirrers 30 each having a respective elongate spindle 31 and a respective one or more paddles 36 attached to and extending radially outward from the respective spindle 31, wherein each spindle 31 has a respective spindle axis 35 and wherein the one or more stirrers 30 are disposed with each spindle 31 oriented in a respective generally vertical, generally horizontal or generally diagonal orientation with the respective one or more paddles 36 disposed within the defined volume 29, wherein each of the one or more stirrers 30 is configured for rotation about its respective spindle axis 35 such that rotation of the respective one or more paddles 36 sweeps out and defines a respective individual paddle-swept volume Vᵢₚₛ, wherein a totality of the individual paddle-swept volumes Vᵢₚₛ defines a collective paddle-swept volume V_{cps}; and (iii) a sensor 43 disposed within the defined volume 29 and outside the collective paddle-swept volume V_{cps}, wherein the sensor 43 is configured for sensing the quality characteristic QC.

The quality characteristic QC may be at least one of resistivity QCᵣ and dielectric permittivity QC_{dp}.

For each of the one or more stirrers 30, the respective one or more paddles 36 may be attached to the stirrer 30 via a respective one or more arms 40.

The vessel 22 may have a generally vertically oriented longitudinal axis A, wherein one or more of the one or more stirrers 30 are disposed with their respective spindle axes 35 being generally colinearly aligned with the longitudinal axis A.

The vessel 22 may have a vessel radius Rᵥ as measured from the longitudinal axis A and wherein the collective paddle-swept volume V_{cps} extends radially outward from the longitudinal axis A to a maximum paddle-swept radius Rₘₚₛ, such that the maximum paddle-swept radius Rₘₚₛ is less than the vessel radius Rᵥ.

The sensor 43 may be disposed at a sensor radius Rₛ as measured from the longitudinal axis A, such that the sensor radius Rₛ is greater than the maximum paddle-swept radius Rₘₚₛ and less than the vessel radius Rᵥ.

The system 20 may further include an elongate extension 50 having a top extension end 51 and a bottom extension end 52, wherein the extension 50 is disposed in a generally vertical orientation with the bottom extension end 52 attached to the sensor 43.

The extension 50 may be configured as a tube 53 having a lumen 54 therein, and at least one sensor wire 46 may extend within the lumen 54 and may be operably connected with the sensor 43.

The sensor 43 may be configured for at least one of continuous monitoring and intermittent monitoring.

The slurry 10 may be a battery electrode slurry 12 containing ceramic particles 14 therein.

The sensor 43 may be positioned within the defined volume 29 at a location 47 having a lowest flow rate FR during rotation of the one or more stirrers 30.

The sensor 43 may include at least one of a surface coating 48 of a ceramic material 49 on a sensing surface 45ₛ of the sensor 43, a baffle 69 disposed so as to at least partially block a flow of the slurry 10 to the sensing surface 45ₛ and configured to reduce at least one of a velocity V and a turbulence T of the slurry 10 impinging on the sensing surface 45ₛ, and a case 70 surrounding the sensing surface 45ₛ and having a flow inlet 71 for admitting the slurry 10 into a chamber 72 within which the sensing surface 45ₛ is disposed and a flow outlet 73 for admitting the slurry 10 out of the chamber 72.

The case 70 may include at least one of a case inlet valve 74 in fluid communication with the flow inlet 71, a case outlet valve 75 in fluid communication with the flow outlet 73, and a conductive shielding 78 on at least one of an inner case surface 76 and an outer case surface 77 of the case 70.

According to another embodiment, a system 20 for in-line monitoring of a quality characteristic QC of a slurry 10 includes: (i) a vessel 22 having a vessel side wall 23 defining a vessel interior 28 and a conduit 55 disposed outside the vessel side wall 23, wherein the conduit 55 includes a conduit inlet 56 in fluid communication with the vessel interior 28 and a conduit outlet 57 in fluid communication with the vessel interior 28, wherein the vessel 22 is configured to receive the slurry 10 and to contain the slurry 10 within a defined volume 29 that is within the vessel interior 28 and the conduit 55; (ii) one or more stirrers 30 disposed within the vessel interior 28 and configured for stirring the slurry 10; and (iii) a sensor 43 having a sensing surface 45ₛ that is disposed within the conduit 55, wherein the sensor 43 is configured for sensing the quality characteristic QC.

The sensor 43 may be configured for at least one of continuous monitoring and intermittent monitoring.

The sensor 43 may include at least one of a surface coating 48 of a ceramic material 49 on a sensing surface 45ₛ of the sensor 43, a baffle 69 disposed so as to at least partially block a flow of the slurry 10 to the sensing surface 45ₛ and configured to reduce at least one of a velocity V and a turbulence T of the slurry 10 impinging on the sensing surface 45ₛ, and a case 70 surrounding the sensing surface 45ₛ and having a flow inlet 71 for admitting the slurry 10 into a chamber 72 within which the sensing surface 45ₛ is disposed and a flow outlet 73 for admitting the slurry 10 out of the chamber 72.

The case 70 may include at least one of a case inlet valve 74 in fluid communication with the flow inlet 71, a case outlet valve 75 in fluid communication with the flow outlet 73, and a conductive shielding 78 on at least one of an inner case surface 76 and an outer case surface 77 of the case 70.

The conduit 55 may include at least one of a conduit inlet valve 58 in fluid communication with the conduit inlet 56, a conduit outlet valve 59 in fluid communication with the conduit outlet 57, and a flow rate controller 66 disposed in a conduit channel 63 of the conduit 55 for regulating a flow rate FR of the slurry 10 through the conduit channel 63.

The conduit 55 may include a conductive shielding 78 on at least one of an inner conduit surface 61 and an outer conduit surface 62 of the conduit 55.

According to yet another embodiment, a method 100 for in-line monitoring of a quality characteristic QC of a slurry 10 includes: (a) providing a system 20 which includes (i) a vessel 22 having a vessel side wall 23 defining a vessel interior 28, wherein the vessel 22 is configured to receive the slurry 10 and to contain the slurry 10 within a defined volume 29 that is within the vessel interior 28; (ii) one or more stirrers 30 each having a respective elongate spindle 31 and a respective one or more paddles 36 attached to and extending radially outward from the respective spindle 31, wherein each spindle 31 has a respective spindle axis 35 and wherein the one or more stirrers 30 are disposed with each spindle 31 oriented in a respective generally vertical, generally horizontal or generally diagonal orientation with the respective one or more paddles 36 disposed within the defined volume 29, wherein each of the one or more stirrers 30 is configured for rotation about its respective spindle axis 35 such that rotation of the respective one or more paddles 36 sweeps out and defines a respective individual paddle-swept volume Vᵢₚₛ, wherein a totality of the individual paddle-swept volumes Vᵢₚₛ defines a collective paddle-swept volume V_{cps}; and (iii) a sensor 43 disposed within the defined volume 29 and outside the collective paddle-swept volume V_{cps}; (b) adding the slurry 10 into the vessel 22; (c) stirring the slurry 10 with the one or more stirrers 30; and (d) sensing the slurry 10 with the sensor 43 so as to determine the quality characteristic QC of the slurry 10.

According to yet a further embodiment, a method 200 for in-line monitoring of a quality characteristic QC of a slurry 10 includes: (a) providing a system 20 which includes (i) a vessel 22 having a vessel side wall 23 defining a vessel interior 28 and a conduit 55 disposed outside the vessel side wall 23, wherein the conduit 55 includes a conduit inlet 56 in fluid communication with the vessel interior 28 and a conduit outlet 57 in fluid communication with the vessel interior 28, (ii) one or more stirrers 30 disposed within the vessel interior 28 and configured for stirring the slurry 10, and (iii) a sensor 43 having a sensing surface 45 that is disposed within the conduit 55; (b) adding the slurry 10 into the vessel 22; (c) stirring the slurry 10 with the one or more stirrers 30; and (d) sensing the slurry 10 within the conduit 55 with the sensor 43 so as to determine the quality characteristic QC of the slurry 10. The system 20 may include a conduit channel 63 defined within the conduit 55 and fluidly coupling the conduit inlet 56 and the conduit outlet 57, and the method 200 may further include: (e) opening one or both of a conduit inlet valve 58 disposed in the conduit channel 63 proximate the conduit inlet 56 and a conduit outlet valve 59 disposed in the conduit channel 63 proximate the conduit outlet 57. The method 200 may also include: (f) closing one or both of the conduit inlet valve 58 and the conduit outlet valve 59.

While various steps of the method 100 have been described as being separate blocks, and various functions of the system 20 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at”or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A system for in-line monitoring of a quality characteristic of a slurry, comprising:
a vessel having a vessel side wall defining a vessel interior, wherein the vessel is configured to receive the slurry and to contain the slurry within a defined volume that is within the vessel interior;
one or more stirrers each having a respective elongate spindle and a respective one or more paddles attached to and extending radially outward from the respective spindle, wherein each spindle has a respective spindle axis and wherein the one or more stirrers are disposed with each spindle oriented in a respective generally vertical, generally horizontal or generally diagonal orientation with the respective one or more paddles disposed within the defined volume, wherein each of the one or more stirrers is configured for rotation about its respective spindle axis such that rotation of the respective one or more paddles sweeps out and defines a respective individual paddle-swept volume, wherein a totality of the individual paddle-swept volumes defines a collective paddle-swept volume; and
a sensor disposed within the defined volume and outside the collective paddle-swept volume, wherein the sensor is configured for sensing the quality characteristic.

2. The system of claim 1, wherein for each of the one or more stirrers, the respective one or more paddles are attached to the stirrer via a respective one or more arms.

3. The system of claim 1, wherein the vessel has a generally vertically oriented longitudinal axis, and wherein one or more of the one or more stirrers are disposed with their respective spindle axes being generally colinearly aligned with the longitudinal axis.

4. The system of claim 1, wherein the quality characteristic is at least one of resistivity and dielectric permittivity.

5. The system of claim 3, wherein the vessel has a vessel radius as measured and wherein the collective paddle-swept volume extends radially outward from the longitudinal axis to a maximum paddle-swept radius, such that the maximum paddle-swept radius is less than the vessel radius.

6. The system of claim 5, wherein the sensor is disposed at a sensor radius with respect to the longitudinal axis, such that the sensor radius is greater than the maximum paddle-swept radius and less than the vessel radius.

7. The system of claim 1, further comprising:
an elongate extension having a top extension end and a bottom extension end, wherein the extension is disposed in a generally vertical orientation with the bottom extension end attached to the sensor.

8. The system of claim 7, wherein the extension is configured as a tube having a lumen therein, and wherein at least one sensor wire extends within the lumen and is operably connected with the sensor.

9. The system of claim 1, wherein the sensor is configured for at least one of continuous monitoring and intermittent monitoring.

10. The system of claim 1, wherein the slurry is a battery electrode slurry containing ceramic particles therein.

11. The system of claim 1, wherein the sensor is positioned within the defined volume at a location having a lowest flow rate during rotation of the one or more stirrers.

12. The system of claim 1, wherein the sensor includes at least one of:
a surface coating of a ceramic material on a sensing surface of the sensor;
a baffle disposed so as to at least partially block a flow of the slurry to the sensing surface and configured to reduce at least one of a velocity and a turbulence of the slurry impinging on the sensing surface; and
a case surrounding the sensing surface and having a flow inlet for admitting the slurry into a chamber within which the sensing surface is disposed and a flow outlet for admitting the slurry out of the chamber.

13. The system of claim 12, wherein the case includes at least one of:
a case inlet valve in fluid communication with the flow inlet;
a case outlet valve in fluid communication with the flow outlet; and
a conductive shielding on at least one of an inner case surface and an outer case surface of the case.

14. A system for in-line monitoring of a quality characteristic of a slurry, comprising:
a vessel having a vessel side wall defining a vessel interior and a conduit disposed outside the vessel side wall, wherein the conduit includes a conduit inlet in fluid communication with the vessel interior and a conduit outlet in fluid communication with the vessel interior, wherein the vessel is configured to receive the slurry and to contain the slurry within a defined volume that is within the vessel interior and the conduit;
one or more stirrers disposed within the vessel interior and configured for stirring the slurry; and
a sensor having a sensing surface that is disposed within the conduit, wherein the sensor is configured for sensing the quality characteristic.

15. The system of claim 14, wherein the sensor is configured for at least one of continuous monitoring and intermittent monitoring.

16. The system of claim 14, wherein the sensor includes at least one of:
a surface coating of a ceramic material on a sensing surface of the sensor;
a baffle disposed so as to at least partially block a flow of the slurry to the sensing surface and configured to reduce at least one of a velocity and a turbulence of the slurry impinging on the sensing surface; and
a case surrounding the sensing surface and having a flow inlet for admitting the slurry into a chamber within which the sensing surface is disposed and a flow outlet for admitting the slurry out of the chamber.

17. The system of claim 16, wherein the case includes at least one of:
a case inlet valve in fluid communication with the flow inlet;
a case outlet valve in fluid communication with the flow outlet; and
a conductive shielding on at least one of an inner case surface and an outer case surface of the case.

18. The system of claim 14, wherein the conduit includes at least one of:
a conduit inlet valve in fluid communication with the conduit inlet;
a conduit outlet valve in fluid communication with the conduit outlet; and
a flow rate controller disposed in a conduit channel of the conduit for regulating a flow rate of the slurry through the conduit channel.

19. The system of claim 14, wherein the conduit includes a conductive shielding on at least one of an inner conduit surface and an outer conduit surface of the conduit.

20. A method for in-line monitoring of a quality characteristic of a slurry, comprising:
providing a system which includes (i) a vessel having a vessel side wall defining a vessel interior and a conduit disposed outside the vessel side wall, wherein the conduit includes a conduit inlet in fluid communication with the vessel interior and a conduit outlet in fluid communication with the vessel interior (ii) one or more stirrers disposed within the vessel interior and configured for stirring the slurry, and (iii) a sensor having a sensing surface that is disposed within the conduit;
adding the slurry into the vessel;
stirring the slurry with the one or more stirrers; and
sensing the slurry within the conduit with the sensor so as to determine the quality characteristic of the slurry.
